(19) United States
(12) Patent Application Publication
(10) Pub. No.: US 2010/0312413 A1
(43) Pub. Date: Dec. 9, 2010

(54) ADVANCED WIRELESS PROJECTOR PRESENTATION SYSTEM WITH NETWORK MANAGEMENT CONTROL

(75) Inventor: Sho-Chaug SUN, Zhonghe City (TW)

Correspondence Address: YOUNG & THOMPSON, 209 Madison Street, Suite 500, Alexandria, VA, 22314, US

(73) Assignee: VIEWSONIC CORPORATION, ZHONGHE CITY (TW)

(21) Appl. No.: 12/478,102

(22) Filed: Jun. 4, 2009

(51) Int. Cl. G06F 1/32

(52) U.S. Cl. 700/295

(57) ABSTRACT

An advanced wireless projector presentation system with network management control includes a LAN; an intranet wireless router connected to the LAN; an administrator computer connected to the LAN via the router; and multiple workgroups, each of which includes at least one projector and at least one presenter computer. The projectors each is connected to the LAN via an RJ45 network cable, and allows the administrator computer to access the projectors for presenting images and to control the on, off, and standby of the projectors. The presenter computers are connected to the LAN via the router, so as to use the projectors in the same workgroup to project images. Meanwhile, the administrator computer can also directly control the projectors in every workgroup. Therefore, the projector presentation system can be conveniently used in a wide working environment through good network management control without the need of complicated wiring.

### BACKGROUND OF THE INVENTION

1. Field of the Invention

The present invention relates to an advanced wireless projector presentation system with network management control, and more particularly to a projector presentation system that can be conveniently used in a wide area working environment through good network management control.

2. Description of the Prior Arts

Please refer to FIG. 4, which is a system diagram showing a projector network management control based on prior arts. As shown, multiple projectors 90 are connected via RJ45 network cables to a local network 91, and the local network 91 is connected via another RJ45 network cable to an administrator computer 92. With these arrangements, a user can use network cables as transmission means to control the projectors 90 located at different points to project images. Moreover, the local network 91 can be further connected to an external network 93, so that users at remote locations can also access the data being presented via the projectors 90. However, in implementing the above projector network management control, the wiring thereof is troublesome, and it is uneasy to connect every projector 90 to multiple presenter computers to allow multiple presenters to share the projector 90.

FIG. 5 is a system diagram showing a wireless presentation projector according to the existing techniques. As shown, the conventional projector 80 has an internal 802.11 wireless local area network (WLAN) receiver 81, and a network protocol device 83 is provided on each of multiple presenter computers 82 for the latter to share the projector 80. The projector 80 is connected via an RJ45 network cable to a local network 84, so that other users can access related information via the local network 84; and the local network 84 can be further connected to Internet 85 for any remote users to access related information. However, in the event the projector 80 is provided in each of multiple rooms and it is desirable these projectors 80 are managed and controlled under the same one system, it would be inconvenient and uneasy to set up these projectors 80 with the above-described technical means. Further, since there is not a general controller for controlling and managing all the projectors 80, the above-described wireless presentation projector system has the problem of poor control and management.

From the above analyses, it is found the wired and wireless presentation projector systems being used in a working environment have their own advantages and disadvantages. However, since these two types of systems involve different technical fields, there is not any currently available design that combines the advantages of these two systems while omits the disadvantages thereof. That is, up to date, there is not any projector presentation network system that is easy to control and management and convenient for use.

It is therefore tried by the inventor to develop an advanced wireless projector presentation system with network management control.

### SUMMARY OF THE INVENTION

A primary object of the present invention is to provide an advanced wireless projector presentation system with network management control, so as to overcome the problem of uneasy to manage and control projectors in different presentation rooms via a network as found with the conventional wired and wireless projector presentation systems.

To achieve the above and other objects, the advanced wireless projector presentation system with network management control according to a preferred embodiment of the present invention includes:

a local area network (LAN);

an intranet wireless router being connected to the LAN via an RJ45 network cable to serve as an interconnection center between a wireless network and a wired network;

an administrator computer being a computer capable of working with an 802.11 wireless LAN (WLAN), and being connected to the LAN via the intranet wireless router in order to transmit and access data; the administrator computer having Projector Network Management Control Application Software and Presentation Management Application Software installed thereon, and, via the LAN, the administrator computer being able to transmit intra\internet data instructions and presentation\video data to be presented; and

multiple workgroups, each of which includes at least one projector and at least one presenter computer.

The projector is connected to the LAN via an RJ45 network cable, and receives intra\internet data instructions and presentation\video data from the administrator computer and allows the administrator computer to access the projector for presenting images and to control the on, off, and standby of the projector. The projector is provided with a network control integration module, which processes the intra\internet data and the presentation\video data sent from the LAN to the projector. The network control integration module includes a projector network management control signal receiver unit and a compressed presentation\video data decompression unit. The projector network management control signal receiver unit receives and determines the intra\internet data instruction, and is electrically connected to and controls a projector control function central processing unit (CPU) of the projector. The decompression unit receives and decrypts the presentation\video data, and is electrically connected to a player of the projector.

The presenter computer is a computer capable of working with an 802.11 WLAN and has Presentation Management Application Software installed thereon, so as to connect to the LAN via the intranet wireless router to transmit the presentation\video data to the projectors in the same workgroup for presentation.

When the advanced wireless projector presentation system with network management control of the present invention is used in a working environment, the presenter computers in one presentation room can utilize the projectors in the same workgroup to project images. In addition, the administrator computer can also directly controls the projectors of different workgroups in several presentation rooms to project images. Further, since different actions, such as power-on, power-off, and image presentation, of the projectors under different workgroups can be directly controlled via the administrator computer, the advanced wireless projector presentation system with network management control of the present invention is highly convenient for use through effective network management control. Moreover, the complicated wiring of network cables as needed in the prior art can be omitted from the working environment when the present invention is adopted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system diagram of an advanced wireless projector presentation system with network management control according to a preferred embodiment of the present invention.

FIG. 2 is a schematic view showing part of the components of the present invention;

FIG. 3 is a diagram view of an advanced wireless projector presentation system with network management control according to another preferred embodiment of the present invention;

FIG. 4 is a system diagram of a conventional projector network management and control system; and

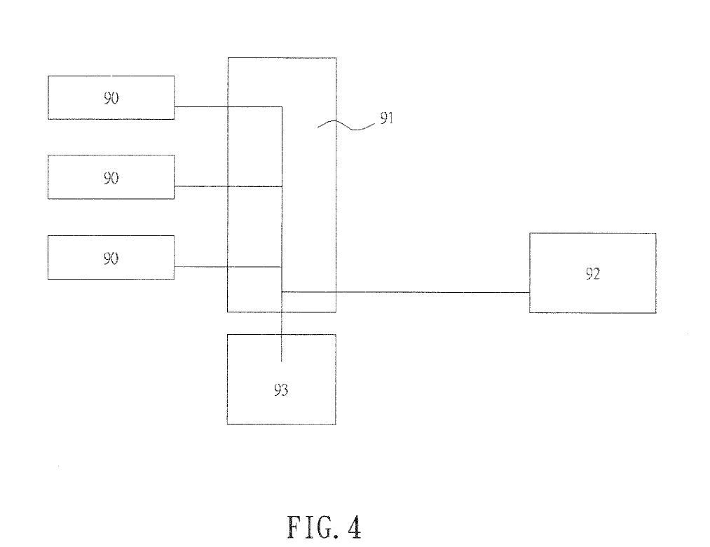

FIG. 5 is a system diagram of a conventional wireless presentation projector.

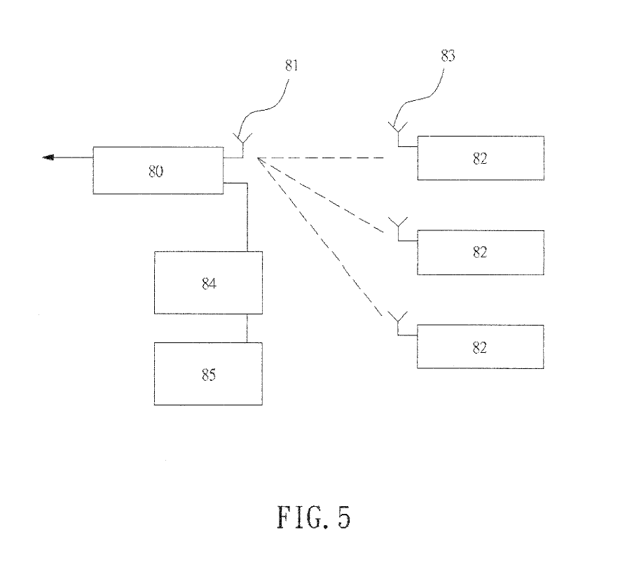

### DETAILED DESCRIPTION OF THE PREFERRED EMBODIMENTS

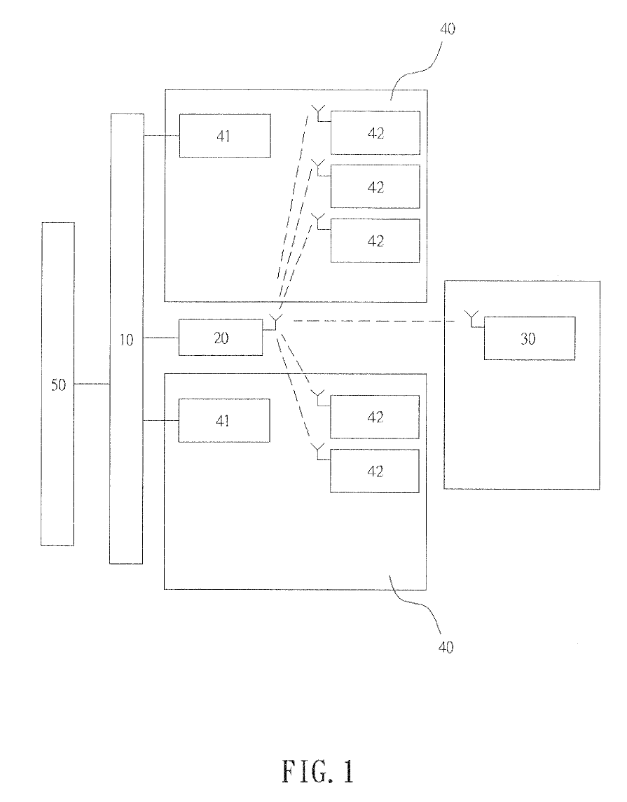

Please refer to FIG. 1. An advanced wireless projector presentation system with network management control according to a preferred embodiment of the present invention can be set up in a working environment, such as an office building, a school, a governmental agency, or any plant house. Such working environment can be further divided into multiple presentation rooms, such as meeting rooms, classrooms, etc., so that reports or teaching or the like can be conducted in these presentation rooms. In the preferred embodiment of the present invention, the advanced wireless projector presentation system with network management control includes a local area network (LAN) 10, an intranet wireless router 20, an administrator computer 30, and multiple workgroups 40.

The LAN 10 is set up in the above-mentioned working environment suitable for the present invention, and can be set up using currently available networking techniques. The LAN 10 can be further linked with an external network, such as Internet 50.

The intranet wireless router 20 is an 802.11 wireless local area network (WLAN) router, and is connected to the LAN 10 via an RJ45 network cable to serve as an interconnection center between a wireless network and a wired network.

The administrator computer 30 is a computer capable of working with an 802.11 WLAN, and is connected to the LAN 10 via the intranet wireless router 20 in order to transmit and access data. The administrator computer 30 has related application software installed thereon, such as Projector Network Management Control Application Software and Presentation Management Application Software. Via the LAN 10, the administrator computer 30 can transmit intra\internet data instructions and presentation\video data to be projected by a presenter.

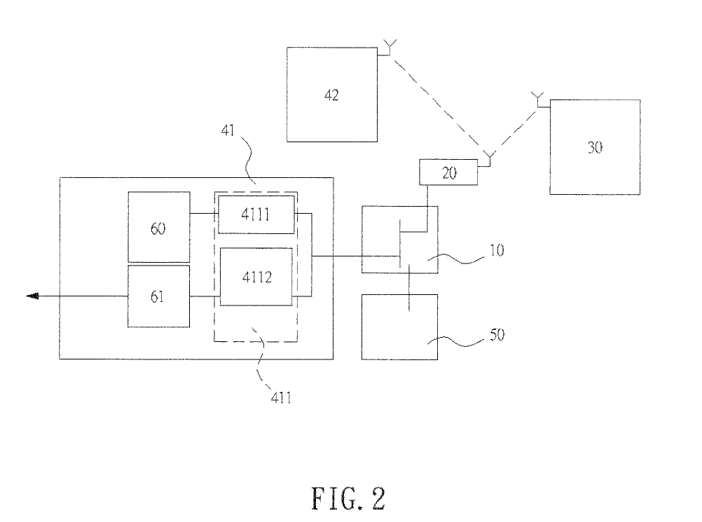

Please refer to FIG. 2. Each of the workgroups 40 is located in a presentation room, and can include at least one projector 41 and at least one presenter computer 42.

The projector 41 is connected to the LAN 10 via an RJ45 network cable and controlled by the administrator computer 30, so that a user at the administrator computer 30 is allowed to access the projector 41 for presenting images and to control the on, off, and standby of the projector 41. For this purpose, the projector 41 must be provided with a network control integration module 411, which can be built in or externally connected to the projector 11 to directly process the intra\internet data and the presentation\video data sent to the projector 41 via the LAN 10. The network control integration module 411 includes a projector network management control signal receiver unit 4111 and a compressed presentation\video data decompression unit 4112.

The projector network management control signal receiver unit 4111 receives and determines the intra\internet data instruction, and is electrically connected to and controls a projector control function central processing unit (CPU) 60 of the projector 41, so as to receive a control instruction from the administrator computer 30 for driving the projector 41 to complete corresponding actions, such as power-on, power-off, standby, present, etc.

The decompression unit 4112 receives and decrypts the presentation\video data, and is electrically connected to a player 61 of the projector 41 for playing and projecting the presentation\video data sent thereto via the LAN 10.

The presenter computer 42 is a computer capable of working with an 802.11 WLAN and has Presentation Management Application Software installed thereon, so as to connect to the LAN 10 via the intranet wireless router 20 to transmit the presentation\video data to the projectors 41 in the same workgroup 40 for presentation.

When the advanced wireless projector presentation system with network management control of the present invention is used in a working environment, users at the presenter computers 42 in the same one presentation room can utilize the projectors 41 in the same workgroup 40 in a one-to-one correspondence to project images to conduct report or teaching. In addition, it is also possible to use the administrator computer 30 to directly control the projectors 41 of different workgroups 40 in several presentation rooms in a one-to-many correspondence to project images. Thus, a message can be very conveniently released to all persons in different presentation rooms at the same time. Further, since different actions, such as power-on, power-off and image presentation, of the projectors 41 under different workgroups 40 can be directly controlled via the administrator computer 30, giving the advanced wireless projector presentation system with network management control of the present invention a significant characteristic of allowing centralized control. Moreover, since the present invention is operated mainly on a wireless basis, the complicated wiring of network cables as needed in the prior art can be omitted from the working environment the present invention is adopted.

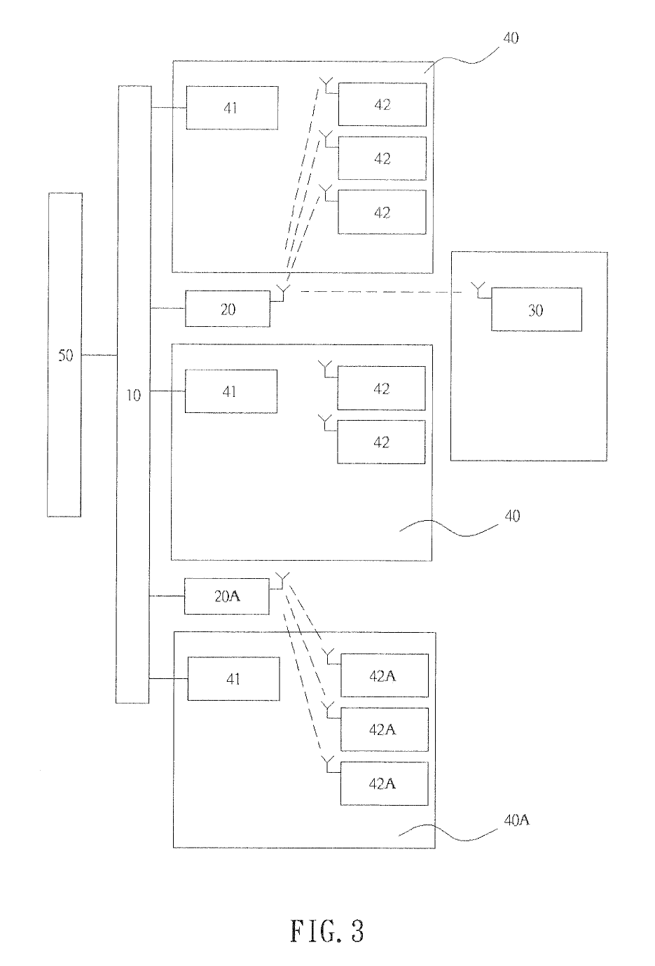

FIG. 3 is a system view of an advanced wireless projector presentation system with network management control according to another preferred embodiment of the present invention. In the case the presentation rooms in the working environment are located distant from one another, an additional intranet wireless router 20A can be further provided at the relatively remote presentation rooms for interconnecting the LAN 10 and the presenter computers 42A of the workgroups 40A in the remote presentation rooms. With this arrangement, the present invention can be applied to an extremely wide working environment.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An advanced wireless projector presentation system with network management control, comprising:
a LAN;
an intranet wireless router being connected to the LAN via an RJ45 network cable, serving as an interconnection center between a wireless network and a wired network;
an administrator computer being capable of working with an 802.11 WLAN, and being connected to the LAN via the intranet wireless router in order to transmit and access data; the administrator computer having Projector Network Management Control Application Software and Presentation Management Application Software installed thereon; and, via the LAN, the administrator computer being able to transmit intra\internet data instructions and presentation\video data to be projected by a presenter; and
multiple workgroups, each of which having at least one projector and at least one presenter computer;
the projector being connected to the LAN via an RJ45 network cable and being controlled by the administrator computer, and allowing the administrator computer to access the projector for presenting images and to control the on, off, and standby of the projector; the projector being provided with a network control integration module processing the intra\internet data and the presentation\video data being sent to the projector via the LAN; the network control integration module including a projector network management control signal receiver unit and a compressed presentation data decompression unit; the projector network management control signal receiver unit receiving and determining the intra\internet data instruction, and being electrically connected to and controlling a projector control function CPU of the projector; the decompression unit receiving and decrypting the presentation\video data, and being electrically connected to a player of the projector; and
the presenter computer being capable of working with an 802.11 WLAN and having Presentation Management Application Software installed thereon, so as to connect to the LAN via the intranet wireless router to transmit the presentation\video data to the projectors in the same workgroup for presentation.

2. The advanced wireless projector presentation system with network management control as claimed in claim 1, further comprises at least one additional intranet wireless router for the presenter computers in the workgroups at remote locations to connect thereto.

3. The advanced wireless projector presentation system with network management control as claimed in claim 1, wherein the LAN is externally linked with Internet.

4. The advanced wireless projector presentation system with network management control as claimed in claim 2, wherein the LAN is externally linked with Internet.
